(19) United States
(12) Patent Application Publication
(10) Pub. No.: US 2010/0312630 A1
(43) Pub. Date: Dec. 9, 2010

(54) METHOD AND SYSTEM FOR TRANSMITTING AND REDEEMING ELECTRONIC COUPONS THROUGH USE OF MOBILE DEVICE

(76) Inventors: Tammy Krutchik, Southwest Ranches, FL (US); Jonathan A. Krutchik, Southwest Ranches, FL (US)

Correspondence Address: FELDMAN GALE, P.A., 1700 Market Street, Suite 3130, Philadelphia, PA, 19103, US

(21) Appl. No.: 12/796,093

(22) Filed: Jun. 8, 2010

Related U.S. Application Data
(60) Provisional application No. 61/185,047, filed on Jun. 8, 2009.

(51) Int. Cl. G06Q 30/00; G06K 19/06

(52) U.S. Cl. 705/14.35; 705/14.38; 235/375

(57) ABSTRACT

A method and system for transmitting coupons to a portable multifunction device and for redeeming the coupons is disclosed. In one embodiment of the present invention an application is transmitted or downloaded to a portable multifunction device to allow the device to display an icon of a company offering the coupons. The user will have the option of receiving the new offer utilizing a notification system in which the offer will dynamically appear on the screen of the mobile device with an audible and/or vibrating alert notifying the user of the arrival of a new coupon or offer; this without the need of having the coupon application open. When coupons are expired, the system transmitting the coupons has the ability of deleting the expired offers, or in the alternative, the coupons may be deleted by the application itself.

### CROSS REFERENCE TO RELATED APPLICATIONS

This application claims the benefit of U.S. Provisional Application No. 61/185,047, filed Jun. 8, 2009, the entirety of which is hereby incorporated herein by reference.

### FIELD OF THE INVENTION

The present invention relates to the field of applications for portable multifunction devices such as cellular telephones. More specifically, the invention relates to electronic coupon distribution and redemption through use of mobile devices.

### BACKGROUND OF THE INVENTION

Today, there exist a few techniques for distribution of electronic coupons (e-coupons) to potential customers. A seller of a service or product can distribute mass email messages with e-coupons attached to or within the message. The seller then hopes that at least some of the potential customers who receive the messages will redeem the e-coupons included. Additionally, a seller can post an e-coupon on a web site, whether or not owned by the seller, and hope that a potential customer will see the e-coupon and choose to redeem it. Similar techniques exist for targeted distribution of coupons to attract potential customers who live local to a seller. For example, local restaurants or stores can attempt to attract customers on web pages local to a particular city. A city newspaper may have a website and these local sellers can post e-coupons on the site with the same hope of a customer seeing the e-coupon and choosing to redeem it.

Yet these and other techniques tend to be expensive to sellers and highly inefficient in attracting potential customers. The mass emails and e-coupon distribution carry a fixed cost based upon a hope that a potential customer exists. A seller must pay the website provider in order to put its e-coupons on the website, without any assurance at all that the e-coupons will be requested and redeemed by customers.

Generally, potential customers choose a particular type of service or product and then seek to find the service or product based upon some need, whether such need is based on cost, ease of acquisition, location, or some other factor. Customer service can be enhanced if an e-coupon service were provided based upon an initial inquiry from the customer. In such an example, a seller has a substantially increased opportunity to ensure that an e-coupon is redeemed because the customer initiates the desire for the e-coupon rather than random e-coupons—potentially from numerous establishments—being sent to a customer.

However, a seller needs additional safeguards to ensure that distributed e-coupons will be redeemed not only at a high probability, but also at an economic advantage to the seller. A seller wants to issue e-coupons so that a larger number of potential customers will redeem the e-coupons, because the seller has no economic incentive when one or a few customers actually redeem the e-coupons. Additionally, a seller needs to ensure that the distribution of e-coupons does not become economically ineffective by continually distributing e-coupons that are not redeemed.

Technical issues also exist from the standpoint of wireless service providers. In order for a participating seller to send a targeted advertisement to mobile users at a right time and in a right place, the location information of the mobile users must be accurate and monitored closely. To do so, all mobile devices must frequently send location data to the network, and thus cause significant uplink signaling traffic that may eventually overflow the network. The situation could get even worse if the location identification methods are network-based or network-assisted because they consume significant computing resources from the network.

Therefore, a need exists to allow for distribution of e-coupons to potential customers based upon an initial desire from the customer.

### SUMMARY OF THE INVENTION

A method and system for transmitting coupons to a portable multifunction device and for redeeming the coupons is disclosed. In one embodiment of the present invention an application is transmitted or downloaded to a portable multifunction device (e.g., iPhone™) to allow the device to display an icon of a company offering the coupons, such as a restaurant chain. In another embodiment of the invention the icon may represent an individual advertiser or business. The user will have the option of receiving the new offer utilizing a notification system similar in function to receiving a text message (SMS) in which the offer will dynamically appear on the screen of the mobile device with an audible and/or vibrating alert notifying the user of the arrival of a new coupon or offer. By clicking or touching the alert display, the user can then directly view the new coupon or offer. A notification of unread/unopened coupons may be overlaid on the icon so as to attract or direct the device user's attention to a new offer. The coupon and corresponding notification would be pushed into the phone by a server of the company or agent thereof, thereby obviating the need for a proactive request by the user. Upon clicking on or touching the icon on the device screen, the offers or coupons are displayed on the device, without the waiting period that would normally elapse if the coupon were downloaded upon user request, as the coupons are preloaded into and refreshed by a coupon transmission/broadcasting system operated by the company or on behalf of the company. That is, when coupons are expired, the broadcasting system has the ability of deleting the expired offers, or in the alternative, the coupons may be deleted by the application itself.

Thus the company broadcasting the coupons has the ability, through the use of this system, of retrieving or pulling back or revoking coupons that are old or have expired in order to save phone memory space. In one embodiment, this is achieved by what is known in the art as a “software time bomb” mechanism. The coupons can be displayed on the phone screen as an alphanumeric code that can be entered or by bar codes and scanned at an establishment of company location to claim a discount on a given purchase. In one embodiment of the present invention, the application is run together with a secure mobile device credit card or payment module where an alphanumeric code or bar code corresponding to a credit card can be displayed together with the coupon alphanumeric code or bar code to pay for a product and obtain a product discount almost simultaneously.

### BRIEF DESCRIPTION OF THE DRAWINGS

The accompanying drawings, which are incorporated in and constitute a part of this specification, show certain aspects of the present invention and, together with the description, help explain some of the principles associated with the invention.

FIGS. 1 and 2 are block diagrams illustrating exemplary portable multifunction devices with touch-sensitive displays in accordance with some embodiments of the present invention;

FIG. 3 illustrates an exemplary user interface displaying a coupon application in accordance with some embodiments of the present invention;

FIG. 4 illustrates an exemplary user interface displaying offers delivered through a coupon application in accordance with some embodiments of the present invention;

FIG. 5 illustrates an exemplary user interface displaying a specific offer and corresponding alphanumeric coupon code or coupon bar code delivered by a coupon application in accordance with some embodiments of the present invention;

FIG. 6 illustrates an exemplary user interface displaying a bar code corresponding to a credit or debit card or other payment means in accordance with some embodiments of the present invention;

FIG. 7 illustrates an exemplary user interface for implementing a security authentication method used for payment in accordance with some embodiments of the present invention;

FIG. 8 illustrates an exemplary user interface displaying a first bar code corresponding to a credit or debit card or other payment account and a second bar code corresponding to a coupon or offer in accordance with some embodiments of the present invention;

FIG. 9 illustrates an exemplary system for delivering a coupon application to a portable multifunction device and for subscribing to the coupon delivery service in accordance with some embodiments of the present invention;

FIG. 10 illustrates an exemplary user interface displaying an offer notification in accordance with some embodiments of the present invention;

FIG. 11 illustrates an exemplary user interface for displaying promotional information in accordance with some embodiments of the present invention; and

FIG. 12 illustrates an exemplary user interface for displaying read and unread offers in accordance with some embodiments of the present invention.

### DETAILED DESCRIPTION OF ILLUSTRATIVE EMBODIMENTS OF THE INVENTION

Reference will now be made in detail to embodiments, examples of which are illustrated in the accompanying drawings. The following description refers to the accompanying drawings, in which, in the absence of a contrary representation, the same numbers in different drawings represent similar elements. The implementations set forth in the following description do not represent all implementations consistent with the claimed invention. Instead, they are merely some examples of systems and methods consistent with certain aspects related to the invention.

Embodiments of applications executed by portable multifunction devices, user interfaces for such devices, and associated processes for using such devices are described. In some embodiments, the device is a portable communications device such as a mobile telephone that also contains other functions, such as PDA and/or music player functions.

For simplicity, in the discussion that follows, a prior art portable multifunction device that includes a touch screen is used as an exemplary embodiment for executing the applications of the present invention. A prior art portable multifunction device such as an iPhone™ or the device disclosed in U.S. Pat. No. 7,479,949 can be used to execute the applications of the present invention. The applications can also be executed in portable multifunction devices that do not include a touch screen for inputting information, but that rely instead on a more conventional mechanism, for example point-and-click, keypad, keyboard, or click-wheel mechanisms.

In addition to supporting the applications of the present invention, the portable multifunction device described below can support a variety of applications, such as one or more of the following: a telephone application, a video conferencing application, an e-mail application, an instant messaging application, a blogging application, a photo management application, a digital camera application, a digital video camera application, a web browsing application, a digital music player application, and/or a digital video player application.

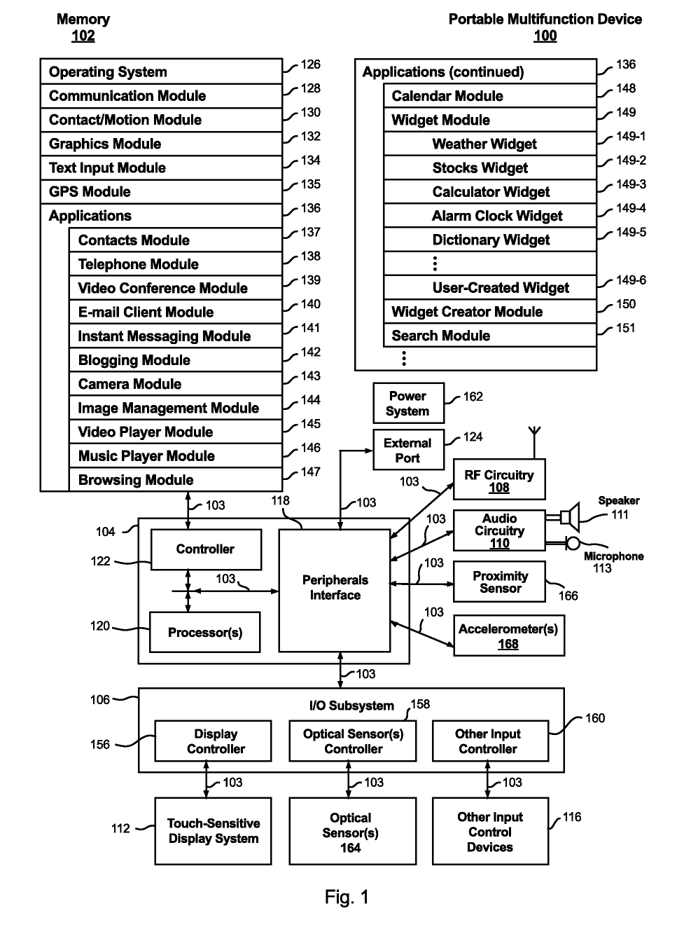

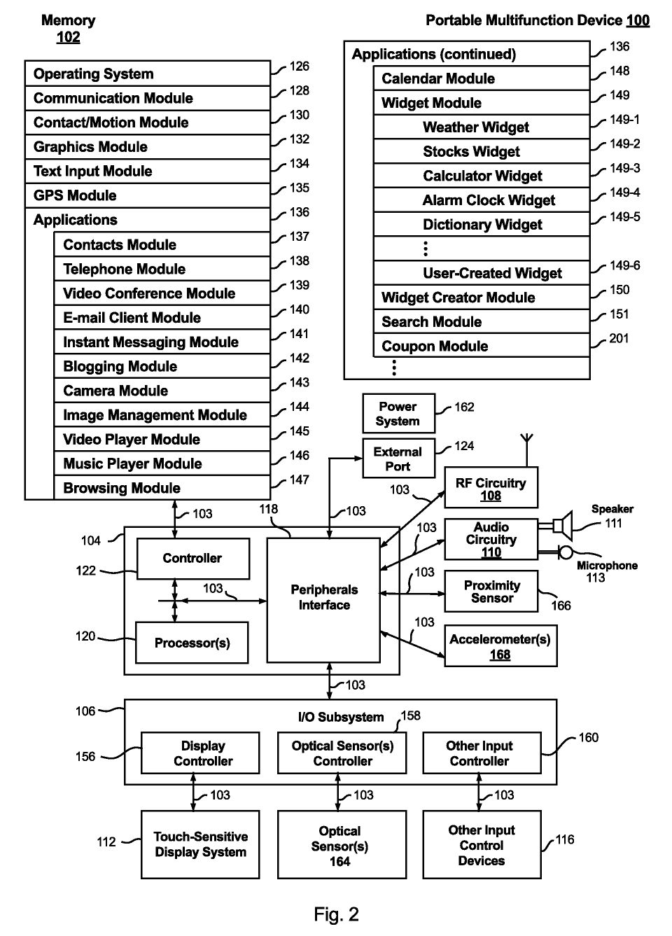

FIGS. 1 and 2 are block diagrams illustrating exemplary prior art portable multifunction devices 100 with touch-sensitive displays 112 modified to include the applications of the present invention. The touch-sensitive display 112 is also known in the art as a touch screen or a touch-sensitive display system. The device 100 may include a memory 102 (which may include one or more computer readable storage mediums), a memory controller 122, one or more processing units (CPU's) 120, a peripherals interface 118, RF circuitry 108, audio circuitry 110, a speaker 111, a microphone 113, an input/output (I/O) subsystem 106, other input or control devices 116, and an external port 124. The device 100 may include one or more optical sensors 164. These components may communicate over one or more communication buses or signal lines 103.

The device 100 is only one example of a portable multifunction device 100 that may be used to execute the applications of the present invention, and that the device 100 may have more or fewer components than shown, may combine two or more components, or a may have a different configuration or arrangement of the components. The various components shown in FIGS. 1 and 2 may be implemented in hardware, software or a combination of both hardware and software, including one or more digital signal processing (“DSP”) circuits and/or application specific integrated circuits (“ASICs”).

Memory 102 may include high-speed random access memory and may also include non-volatile memory, such as one or more magnetic disk storage devices, flash memory devices, or other non-volatile solid-state memory devices. Access to memory 102 by other components of the device 100, such as the CPU 120 and the peripherals interface 118, may be controlled by the memory controller 122.

The peripherals interface 118 couples the input and output peripherals of the device to the CPU 120 and memory 102. The one or more processors 120 run or execute various software programs and/or sets of instructions stored in memory 102 to perform various functions for the device 100 and to process data.

The peripherals interface 118, the CPU 120, and the memory controller 122 may be implemented on a single chip, such as a chip 104. They may also be implemented on separate chips.

The transceiver circuitry 108 receives and sends electromagnetic signals. A person of ordinary skill in the art would recognize that these signals are conventionally referred to as radio frequency (“RF”) signals in the context of portable devices, regardless of whether the signals fall within what is conventionally known as the radio spectrum. The term transceiver circuitry and RF circuitry will be used interchangeably in the present application.

The RF circuitry 108 converts electrical signals to/from electromagnetic signals and communicates information to and from communications networks and other communications devices by modulating/demodulating electromagnetic signals with data corresponding to the information. The RF circuitry 108 may include circuitry known in the art for performing these functions, including but not limited to an antenna system, one or more amplifiers, filters, a tuner, one or more oscillators, a digital signal processor, a CODEC chipset, modulator/demodulator, a subscriber identity module (SIM) card, memory, and so forth. The RF circuitry 108 may communicate with networks, such as the Internet, an intranet and/or a wireless network, such as a cellular telephone network, a wireless local area network (LAN) and/or a metropolitan area network (MAN), and other devices by wireless communication. The wireless communication may use any of a plurality of communications standards, protocols and technologies, including but not limited to Global System for Mobile Communications (GSM), Enhanced Data GSM Environment (EDGE), high-speed downlink packet access (HSDPA), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), and/or Instant Messaging and Presence Service (IMPS)), and/or Short Message Service (SMS)), or any other suitable communication protocol, including communication protocols not yet developed as of the filing date of this application.

The audio circuitry 110, the speaker 111, and the microphone 113 provide an audio interface between a user and the device 100. The audio circuitry 110 receives audio data from the peripherals interface 118, converts the audio data to an electrical signal, and transmits the electrical signal to the speaker 111. The speaker 111 converts the electrical signal to human-audible sound waves. The audio circuitry 110 also receives electrical signals converted by the microphone 113 from sound waves. The audio circuitry 110 converts the electrical signal to audio data and transmits the audio data to the peripherals interface 118 for processing. Audio data may be retrieved from and/or transmitted to memory 102 and/or the RF circuitry 108 by the peripherals interface 118. The audio circuitry 110 may also include a headset jack. The headset jack provides an interface between the audio circuitry 110 and removable audio input/output peripherals, such as output-only headphones or a headset with both output (e.g., a headphone for one or both ears) and input (e.g., a microphone).

The I/O subsystem 106 couples input/output peripherals on the device 100, such as the touch screen 112 and other input/control devices 116, to the peripherals interface 118. The I/O subsystem 106 may include a display controller 156 and one or more input controllers 160 for other input or control devices. The one or more input controllers 160 receive/send electrical signals from/to other input or control devices 116. The other input/control devices 116 may include physical buttons (e.g., push buttons, rocker buttons, etc.), dials, slider switches, joysticks, click wheels, and so forth. Input controller(s) 160 may also be coupled to any (or none) of the following: a keyboard, infrared port, USB port, and a pointer device such as a mouse.

The touch-sensitive touch screen 112 provides an input interface and an output interface between the device and a user. The display controller 156 receives and/or sends electrical signals from/to the touch screen 112. The touch screen 112 displays visual output to the user. The visual output may include graphics, text, icons, video, and any combination thereof (collectively termed “graphics”).

A touch screen 112 has a touch-sensitive surface, sensor or set of sensors that accepts input from the user through tactile contact. The touch screen 112 and the display controller 156 (along with any associated modules and/or sets of instructions in memory 102) detect contact (and any movement or breaking of the contact) on the touch screen 112 and converts the detected contact into interaction with user-interface objects (e.g., one or more soft keys, icons, web pages or images) that are displayed on the touch screen. For example, a point of contact between a touch screen 112 and the user corresponds to a finger of the user.

The touch screen 112 may use LCD (liquid crystal display) technology, or LPD (light emitting polymer display) technology, although other display technologies may also be used. The touch screen 112 and the display controller 156 may detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with a touch screen 112.

The device 100 also includes a power system 162 for powering the various components. The power system 162 may include a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

The device 100 may also include one or more optical sensors 164. FIGS. 1 and 2 show an optical sensor coupled to an optical sensor controller 158 in I/O subsystem 106. The optical sensor 164 may include charge-coupled device (CCD) or complementary metal-oxide semiconductor (CMOS) phototransistors. The optical sensor 164 receives light from the environment, projected through one or more lens, and converts the light to data representing an image. In conjunction with an imaging module 143 (also called a camera module), the optical sensor 164 may capture still images or video. The optical sensor may be located on the back of the device 100, opposite the touch screen display 112 on the front of the device, so that the touch screen display may be used as a viewfinder for either still and/or video image acquisition. An optical sensor may also be located on the front of the device so that the user's image may be obtained for videoconferencing while the user views the other video conference participants on the touch screen display. Preferably, the position of the optical sensor 164 can be changed by the user (e.g., by rotating the lens and the sensor in the device housing) so that a single optical sensor 164 may be used along with the touch screen display for both video conferencing and still and/or video image acquisition.

The device 100 may also include one or more proximity sensors 166. FIGS. 1 and 2 show a proximity sensor 166 coupled to the peripherals interface 118. Alternately, the proximity sensor 166 may be coupled to an input controller 160 in the I/O subsystem 106. The proximity sensor 166 may be used to turn off and disable the touch screen 112 when the multifunction device is placed near the user's ear (e.g., when the user is making a phone call). The proximity sensor can also be used to keep the screen off when the device is in the user's pocket, purse, or other dark area to prevent unnecessary battery drainage when the device is a locked state.

The device 100 may also include one or more accelerometers 168. FIGS. 1 and 2 show an accelerometer 168 coupled to the peripherals interface 118. Alternately, the accelerometer 168 may be coupled to an input controller 160 in the I/O subsystem 106. The accelerometer 168 captures data that is analyzed to determine whether to change a view of information, for example from portrait to landscape, displayed on the screen of the portable device.

The software components stored in memory 102 may include an operating system 126, a communication module (or set of instructions) 128, a contact/motion module (or set of instructions) 130, a graphics module (or set of instructions) 132, a text input module (or set of instructions) 134, a Global Positioning System (GPS) module (or set of instructions) 135, and applications (or set of instructions) 136.

The operating system 126 (e.g., Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communication between various hardware and software components.

The communication module 128 facilitates communication with other devices over one or more external ports 124 and also includes various software components for handling data received by the RF circuitry 108 and/or the external port 124. The external port 124 (e.g., Universal Serial Bus (USB), FIREWIRE, etc.) is adapted for coupling directly to other devices or indirectly over a network (e.g., the Internet, wireless LAN, etc.).

The contact/motion module 130 may detect contact with the touch screen 112 (in conjunction with the display controller 156) and other touch sensitive devices (e.g., a touchpad or physical click wheel). The contact/motion module 130 includes various software components for performing various operations related to detection of contact, such as determining if contact has occurred, determining if there is movement of the contact and tracking the movement across the touch screen 112, and determining if the contact has been broken (i.e., if the contact has ceased). Determining movement of the point of contact may include determining speed (magnitude), velocity (magnitude and direction), and/or an acceleration (a change in magnitude and/or direction) of the point of contact. These operations may be applied to single contacts (e.g., one finger contacts) or to multiple simultaneous contacts (e.g., “multitouch”/multiple finger contacts). Alternatively the contact/motion module 130 and the controller 160 detects contact on a click wheel, for example.

The graphics module 132 includes various known software components for rendering and displaying graphics on the touch screen 112, including components for changing the intensity of graphics that are displayed. As used herein, the term “graphics” includes any object that can be displayed to a user, including without limitation text, web pages, icons (such as user-interface objects including soft keys), digital images, videos, animations and the like.

The text input module 134, which may be a component of graphics module 132, provides soft keyboards for entering text in various applications (e.g., contacts 137, e-mail 140, IM 141, blogging 142, browser 147, and any other application that needs text input).

The GPS module 135 determines the location of the device and provides this information for use in various applications (e.g., to telephone 138 for use in location-based dialing, to camera 143 and/or blogger 142 as picture/video metadata, and to applications that provide location-based services such as weather widgets, local yellow page widgets, and map/navigation widgets).

The applications 136 may include the following modules (or sets of instructions), or a subset or superset thereof: a contacts module 137 (sometimes called an address book or contact list); a telephone module 138; a video conferencing module 139; an e-mail client module 140; an instant messaging (IM) module 141; a blogging module 142; a camera module 143 for still and/or video images; an image management module 144; a video player module 145; a music player module 146; a browser module 147; a calendar module 148; widget modules 149, which may include weather widget 149-1, stocks widget 149-2, calculator widget 149-3, alarm clock widget 149-4, dictionary widget 149-5, and other widgets obtained by the user, as well as user-created widgets 149-6; widget creator module 150 for making user-created widgets 149-6; search module 151; video and music player module 152, which merges video player module 145 and music player module 146; notes module 153; and/or map module 154; and/or online video module 155.

Examples of other applications 136 that may be stored in memory 102 include other word processing applications, JAVA-enabled applications, encryption, digital rights management, voice recognition, and voice replication.

In conjunction with touch screen 112, display controller 156, contact module 130, graphics module 132, and text input module 134, the contacts module 137 may be used to manage an address book or contact list, including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference 139, e-mail 140, or IM 141; and so forth.

In conjunction with RF circuitry 108, audio circuitry 110, speaker 111, microphone 113, touch screen 112, display controller 156, contact module 130, graphics module 132, and text input module 134, the telephone module 138 may be used to enter a sequence of characters corresponding to a telephone number, access one or more telephone numbers in the address book 137, modify a telephone number that has been entered, dial a respective telephone number, conduct a conversation and disconnect or hang up when the conversation is completed. As noted above, the wireless communication may use any of a plurality of communications standards, protocols and technologies.

In conjunction with RF circuitry 108, audio circuitry 110, speaker 111, microphone 113, touch screen 112, display controller 156, optical sensor 164, optical sensor controller 158, contact module 130, graphics module 132, text input module 134, contact list 137, and telephone module 138, the videoconferencing module 139 may be used to initiate, conduct, and terminate a video conference between a user and one or more other participants.

In conjunction with RF circuitry 108, touch screen 112, display controller 156, contact module 130, graphics module 132, and text input module 134, the e-mail client module 140 may be used to create, send, receive, and manage e-mail. In conjunction with image management module 144, the e-mail module 140 makes it easy to create and send e-mails with still or video images taken with camera module 143.

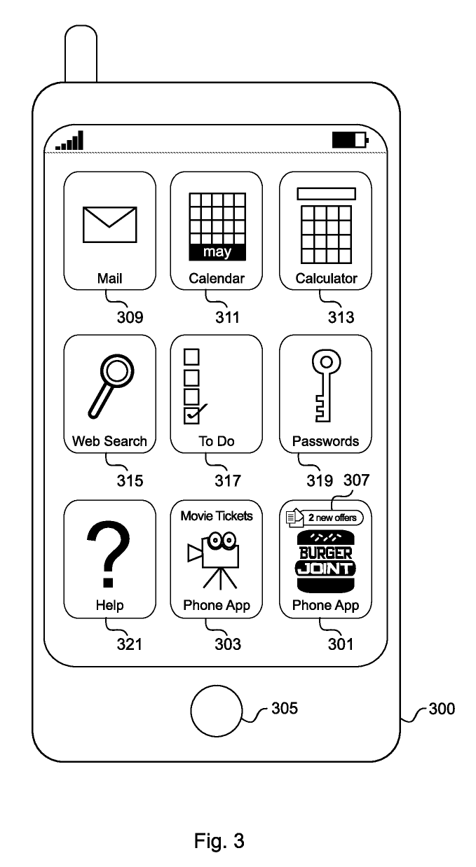

In conjunction with RF circuitry 108, touch screen 112, display controller 156, contact module 130, graphics module 132, and text input module 134, the coupon module 201 may be used to receive and manage coupons as will be described below with reference to FIGS. 3-12. In one embodiment of the present invention the coupon module 201 may be implemented as a widget.

In conjunction with RF circuitry 108, touch screen 112, display controller 156, contact module 130, graphics module 132, and text input module 134, the instant messaging module 141 may be used to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages and to view received instant messages.

In conjunction with RF circuitry 108, touch screen 112, display controller 156, contact module 130, graphics module 132, text input module 134, image management module 144, and browsing module 147, the blogging module 142 may be used to send text, still images, video, and/or other graphics to a blog (e.g., the user's blog).

In conjunction with touch screen 112, display controller 156, optical sensor(s) 164, optical sensor controller 158, contact module 130, graphics module 132, and image management module 144, the camera module 143 may be used to capture still images or video (including a video stream) and store them into memory 102, modify characteristics of a still image or video, or delete a still image or video from memory 102.

In conjunction with touch screen 112, display controller 156, contact module 130, graphics module 132, text input module 134, and camera module 143, the image management module 144 may be used to arrange, modify or otherwise manipulate, label, delete, present (e.g., in a digital slide show or album), and store still and/or video images.

In conjunction with touch screen 112, display controller 156, contact module 130, graphics module 132, audio circuitry 110, and speaker 111, the video player module 145 may be used to display, present or otherwise play back videos (e.g., on the touch screen or on an external, connected display via external port 124).

In conjunction with touch screen 112, display system controller 156, contact module 130, graphics module 132, audio circuitry 110, speaker 111, RF circuitry 108, and browser module 147, the music player module 146 allows the user to download and play back recorded music and other sound files stored in one or more file formats, such as MP3 or AAC files.

In conjunction with RF circuitry 108, touch screen 112, display system controller 156, contact module 130, graphics module 132, and text input module 134, the browser module 147 may be used to browse the Internet, including searching, linking to, receiving, and displaying web pages or portions thereof, as well as attachments and other files linked to web pages.

In conjunction with RF circuitry 108, touch screen 112, display system controller 156, contact module 130, graphics module 132, text input module 134, e-mail module 140, and browser module 147, the calendar module 148 may be used to create, display, modify, and store calendars and data associated with calendars (e.g., calendar entries, to do lists, etc.).

In conjunction with RF circuitry 108, touch screen 112, display system controller 156, contact module 130, graphics module 132, text input module 134, and browser module 147, the widget modules 149 are mini-applications that may be downloaded and used by a user (e.g., weather widget 149-1, stocks widget 149-2, calculator widget 149-3, alarm clock widget 149-4, and dictionary widget 149-5) or created by the user (e.g., user-created widget 149-6). A widget may include an HTML (Hypertext Markup Language) file, a CSS (Cascading Style Sheets) file, and a JavaScript file. A widget may also include an XML (Extensible Markup Language) file and a JavaScript file (e.g., Yahoo! Widgets).

In conjunction with RF circuitry 108, touch screen 112, display system controller 156, contact module 130, graphics module 132, text input module 134, and browser module 147, the widget creator module 150 may be used by a user to create widgets (e.g., turning a user-specified portion of a web page into a widget).

In conjunction with touch screen 112, display system controller 156, contact module 130, graphics module 132, and text input module 134, the search module 151 may be used to search for text, music, sound, image, video, and/or other files in memory 102 that match one or more search criteria (e.g., one or more user-specified search terms).

In conjunction with touch screen 112, display controller 156, contact module 130, graphics module 132, and text input module 134, the notes module 153 may be used to create and manage notes, to do lists, and the like.

In conjunction with RF circuitry 108, touch screen 112, display system controller 156, contact module 130, graphics module 132, text input module 134, GPS module 135, and browser module 147, the map module 154 may be used to receive, display, modify, and store maps and data associated with maps (e.g., driving directions; data on stores and other points of interest at or near a particular location; and other location-based data).

In conjunction with touch screen 112, display system controller 156, contact module 130, graphics module 132, audio circuitry 110, speaker 111, RF circuitry 108, text input module 134, e-mail client module 140, and browser module 147, the online video module 155 allows the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In other modes of operation, instant messaging module 141, rather than e-mail client module 140, is used to send a link to a particular online video.

Each of the above identified modules and applications correspond to a set of instructions for performing one or more functions described above. These modules (i.e., sets of instructions) need not be implemented as separate software programs, procedures or modules, and thus various subsets of these modules may be combined or otherwise rearranged in various embodiments. For example, video player module 145 may be combined with music player module 146 into a single module (e.g., video and music player module 152, FIG. 2). Memory 102 may store a subset of the modules and data structures identified above. Furthermore, memory 102 may store additional modules and data structures not described above.

The device 100 may be a device where operation of a predefined set of functions on the device is performed exclusively through a touch screen 112 and/or a touchpad. By using a touch screen and/or a touchpad as the primary input/control device for operation of the device 100, the number of physical input/control devices (such as push buttons, dials, and the like) on the device 100 may be reduced.

FIG. 3 illustrates an exemplary user interface displaying an icon 301 corresponding to coupon application in accordance with some embodiments of the present invention. The illustrated user interface may be displayed by a conventional portable multifunction device 300 such as an iPhone™ or like apparatus. In addition to the coupon application 301, the user interface may display an email application 309, a calendar application 311, a calculator application 313, a web search application 315, a to-do list application 317, a password application 319, a help application 321, and a movie tickets application 303. The movie tickets application 303, for example, maybe downloaded by users to purchase tickets through the application in a manner similar to the Fandango™ service available over the Internet and accessed through a computer terminal. In such application, for example, the user would select a movie and provide credit card information to purchase the movie ticket. The present invention, while described in reference to a coupon delivery system, is applicable to and has advantages over the movie ticket application 303 described above. These advantages will be described below.

The coupon application can be opened by touching the corresponding icon 301 on the interface or by pointing and clicking on the icon through use of a trackball 305. The icon 301 shown in FIG. 3 displays a notification 307 of two new offers received by the coupon application in a manner similar to that of new text messages notifications in a conventional mobile phone, so as to get the user's attention. In one embodiment of the present invention the new offer or coupon notification may be accompanied by a sound alarm or vibration of the device to indicate the receipt of a new offer.

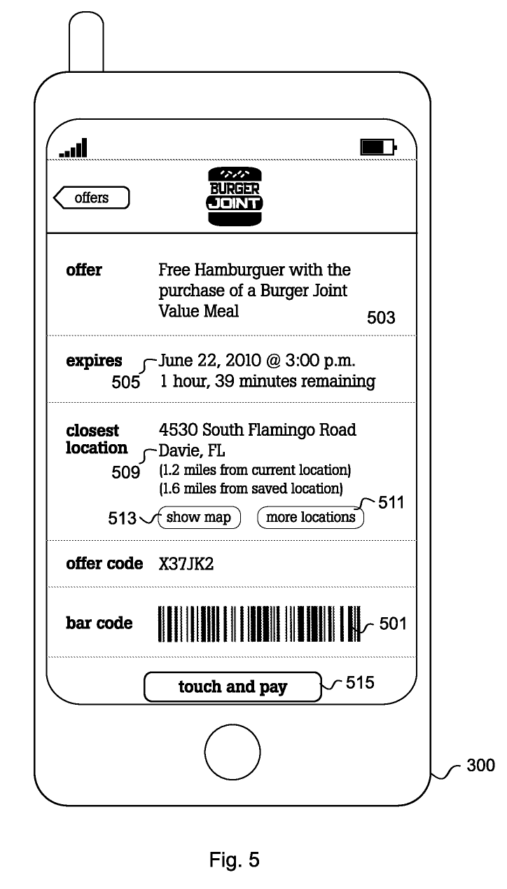

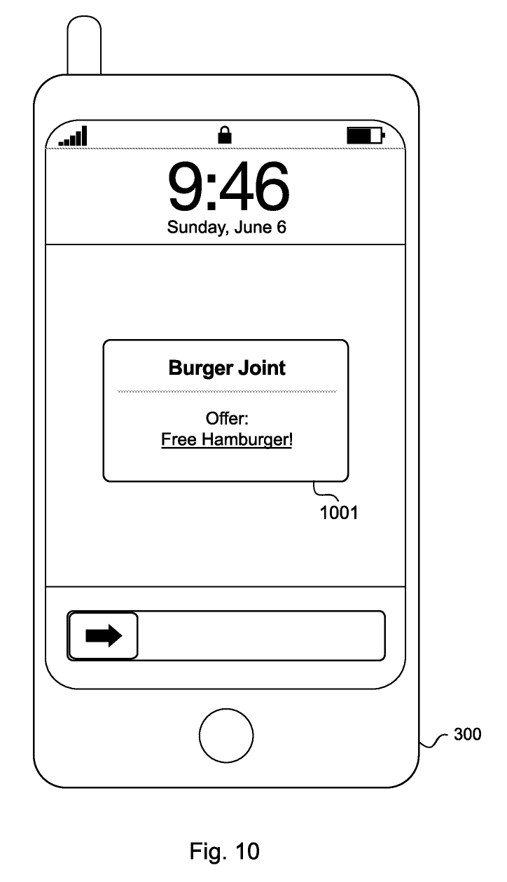

In one embodiment of the present invention, a new offer 1001 may be displayed to the user in a similar fashion to an SMS message (FIG. 10). Upon clicking on the text “Free Hamburger!,” the application will open and the coupon may be displayed to the user. That is, the user may receive notifications of new coupon offers even when the coupon application is not running. In a matter of just one click (or touch) the user may access a bar code (501, FIG. 5), corresponding to a coupon, in real time. The receipt of offers without the coupon application running and the quick access to the coupon bar code constitutes major advantages over the systems of the prior art. These features may be implemented by using the Apple™ Push Notification Service to push information onto the portable device.

These coupons or offers are pushed into the portable device by a server of the business or company issuing the coupons, which in the illustrated example is “Burger Joint.” That server may contain a list of all subscribers. Alternatively the company may use a contractor to support the service.

The application of the present invention allows for marketing intelligence to be programmed into the system and or the application. For example, a restaurant application may display the notification of new offers right before lunch. Likewise, a movie application applying the teachings of the present invention may display new offer notifications on weekends or rainy days when it is more likely that people will attend a movie.

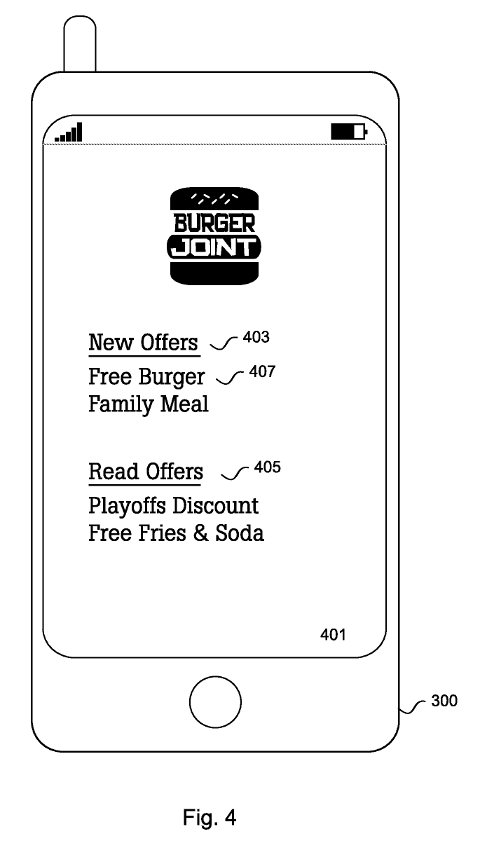

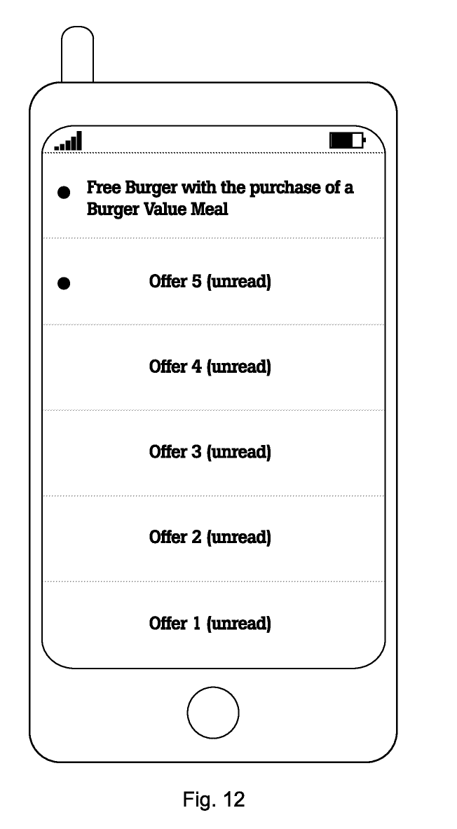

FIG. 4 illustrates an exemplary user interface displaying offers delivered by a coupon application in accordance with some embodiments of the present invention. After clicking on or touching the Burger Joint icon 301 on FIG. 3, the user interface may change as shown in FIG. 4. Alternatively, offers may be displayed as either “read” or “unread” as shown in FIG. 12.

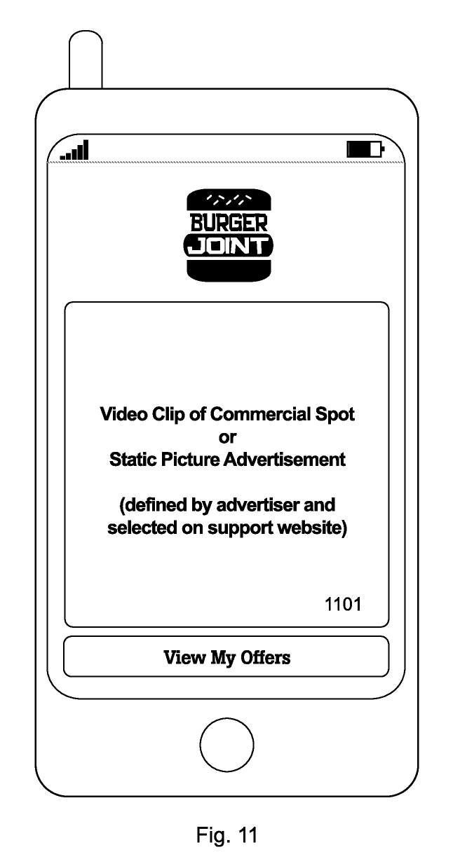

Optionally, once the application icon 301 is selected, a “splash screen” 1101 (FIG. 11) may be used to display a short video (commercial) or a static image with promotional information that would be displayed for a specified duration prior to going to the offer screen. The user interface 401 (FIG. 4) illustrates the two new offers 403 that the user was notified about, but also older offers that may have been read 405 but not yet redeemed and/or have yet to expire. These offers listed may be defined as links that open a new screen with the details of the offer after the user either touches or points and clicks on the link. The unread offers may be displayed at the top of the offer list and have a visual indicator that notifies the user that the offer has not yet been viewed (FIG. 12).

One aspect of the present invention facilitates economy of memory space in the portable device. In one embodiment, the system of the present invention pulls information out of the portable device to determine which offers have expired and upon that determination it commands the application to delete expired offers. In another embodiment of the present invention an expiration date included in the offer or coupon itself may be used by a “software time bomb” mechanism to automatically delete the offer or coupon. In yet another embodiment of the present invention the coupon application inbox may be preprogrammed to automatically delete offers that have been stored in the inbox by more than a predetermined number of days.

FIG. 5 illustrates an exemplary user interface displaying a specific offer 503 and corresponding alphanumeric code (e.g., code “X3YJK2” in FIG. 5) or coupon bar code 501 delivered by a coupon application in accordance with some embodiments of the present invention. After clicking on or touching the “Free Burger” offer 407 displayed in FIG. 4, the user interface displays a new screen as illustrated in FIG. 5.

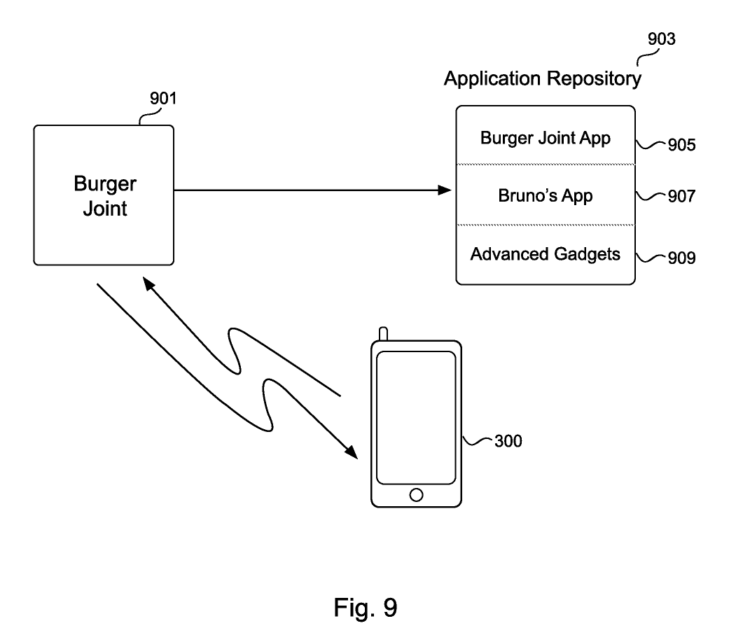

The bar code may be sent by the server of FIG. 9 (Burger Joint server 901) or may be generated by the application locally based on information sent by the server 901 to the device. In one embodiment, when generated locally the bar code 501 may include payment information and/or information identifying the portable device.

FIG. 5 illustrates the user interface displaying information describing the specific new offer 503 “Free Hamburger with the Purchase of a Burger Joint Value Meal.” A similar user interface may be displayed for read but unexpired offers.

The user interface in FIG. 5 also shows the expiration date 505 as well as the time remaining before the offer expires 507. In one embodiment of the invention the GPS module of the portable device may be used by the application of the present invention to identify the business establishment closest to the position of the device 509 where the coupon for the offer may be redeemed. A list of other nearby establishments may be displayed by through the “more locations” option 511. In one embodiment of the present invention a map including these business establishments may be displayed to the user through the “show map” option 513. In addition, the device location information may be uploaded onto the seller's system by the application for targeted advertisement in the form of offers. For example, a franchised business may run a promotion that applies to some but not all establishments in a given area. In that case the map accessed through option 513 illustrated in FIG. 5 may only show the participating establishments. Likewise, it may be the case that a single local establishment may run an offer that only makes sense from a marketing point of view to distribute to residents living nearby.

FIG. 5 also illustrates a bar code 501 with the encoded offer/coupon information. This bar code is pushed onto the device by the push-notification broadcasting system of the present invention and becomes readily accessible once the user opens the coupon application. To redeem the coupon the user would only have to show the portable device to a cashier at a participating establishment for scanning. In one embodiment of the present invention the bar code is scanned using an optical scanner. Alternatively, the user may present an alphanumeric code displayed on the portable device to the cashier.

In one embodiment of the present invention, the user of the portable device can click or touch the button 515 illustrated to pay with the portable device. The inventors of the present invention envision an environment where credit and debit cards will be obsolete. Stores displaying signs where “Blackberry™ accepted” or “iPhone™ accepted,” for example, will be the norm. The teachings of the present invention enable a system whereby payment can be made through the use of the portable device in addition to the coupon or points-based award redemption. The teachings of the present invention allow a portable device to constitute a single solution for saving money, tracking purchases, and paying for goods and services.

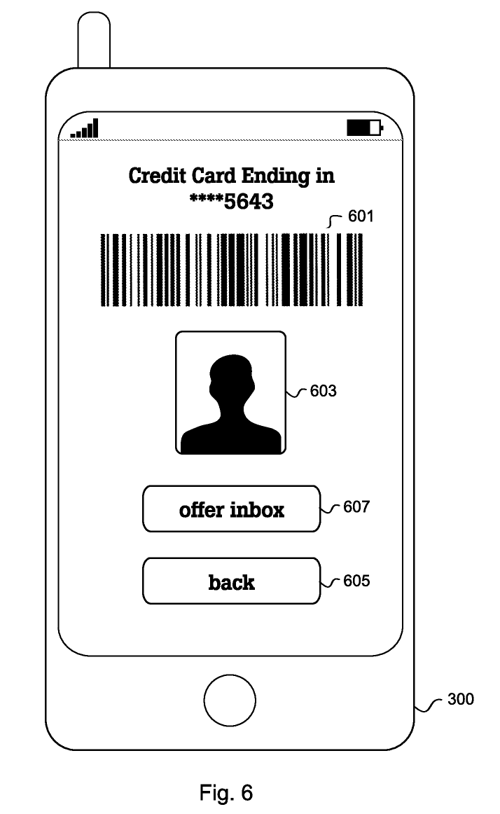

In one embodiment of the invention, the cashier at an establishment can scan a bar code (or other scannable pattern) corresponding to the credit card account information, for example, displayed on the same screen as the coupon bar code, so that both coupon and credit card bar codes can be scanned almost simultaneously. This results in the speedy processing of the coupon redemption and payment transactions. In one embodiment of the present invention, the bar code 601 of FIG. 6, for example, may include both coupon information and payment information.

FIG. 6 illustrates one embodiment of the present invention where a user interface displays a bar code 601 corresponding to a credit/debit card account or other payment account together with means for authenticating the transaction, such as a photo identification 603 of the owner of the account. In one embodiment of the present invention the coupon bar code is first scanned followed by the scanning of the credit account bar code (upon clicking or touching the “touch and pay” button of FIG. 5). The user may choose to go back to the previous screen 605 or go to the offers inbox 607 to access another offer.

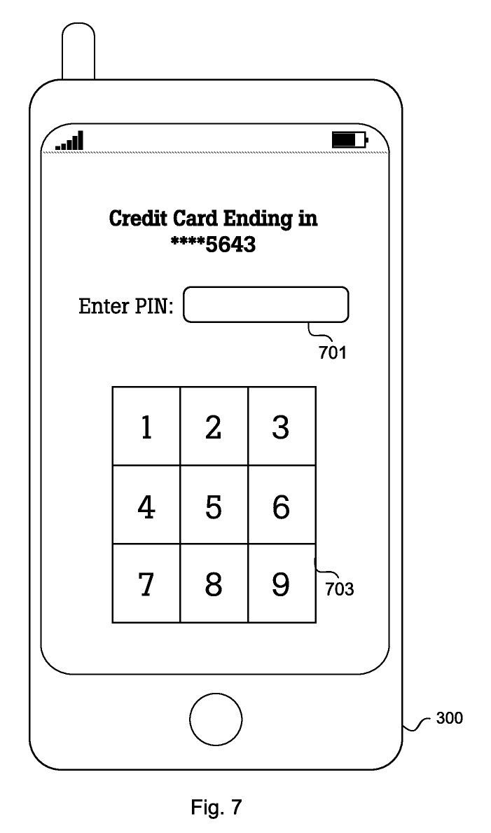

FIG. 7 illustrates an exemplary user interface for implementing a security authentication method used for payment in accordance with some embodiments of the present invention. An alternative authentication method to displaying the picture of the payment account owner is to enter a PIN number 701 (e.g., through use of displayed keypad 703) that has to be processed by the portable device before the device displays a bar code such as the one shown in FIG. 6.

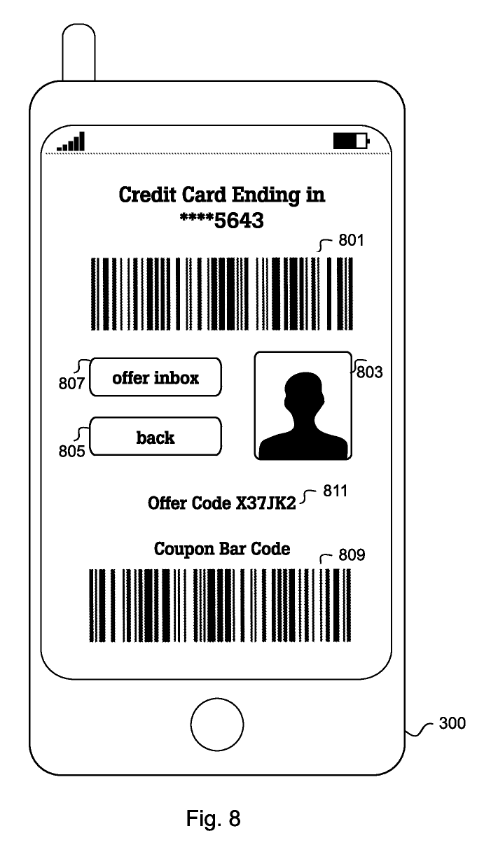

FIG. 8 illustrates an exemplary user interface displaying a first bar code 801 corresponding to a credit or debit card or other payment means and a second bar code 809 corresponding to a coupon or offer in accordance with some embodiments of the present invention. The embodiment illustrated in FIG. 8 allows both payment and coupon redemption through a single scan or scanning movement. In the event that the scanner malfunctions and is unable to scan the bar code, the coupon may still be redeemed by providing the cashier the offer code 811.

The bar code images may be positioned at the opposite ends of the user interface to facilitate the scanning. As in the embodiment illustrated in FIG. 6, the embodiment of FIG. 8 may include a photo identification 803 of the owner of the credit/debit card account (or other payment account) corresponding to the bar code for authentication purposes. Alternatively, a PIN code may be required before bar codes such as those illustrated in FIG. 8 may be displayed to a cashier for payment and coupon redemption.

FIG. 9 illustrates an exemplary system for delivering a coupon application to a portable multifunction device and for subscribing to the coupon delivery service in accordance with some embodiments of the present invention. The delivery system may include a server 901 of the company (e.g., Burger Joint) or agent thereof that maintains a database storage system and implements a data subscription service. The application may be downloaded from the Application Repository 903 shown in FIG. 9. In the illustrated embodiment, the repository includes three applications, the coupon application 905, Bruno's App 907, and advanced gadgets 909. An exemplary application repository can be accessed through http://www.apple.com/iphone/iphone-3gs/app-store.html. Upon the portable device user installing the application 905, a token is generated by the portable device that is passed back to the server which allows future delivery of new offer/coupons. These tokens may serve as unique identifiers for all of the devices that have downloaded the application.

The database system of the present invention stores the information about the specific offers/coupons. For example, the database system may store the offer/coupon, start date, end date, start time, end time, days of the week to run, and storage for images or video clips to be displayed on either the flash page or on the offer page of the application. The company Burger Joint, in the illustrated example, may not necessarily want to incur in the expense of maintaining the server used in keeping track of the subscriptions and therefore, may release coupon information and offers to a contractor or agent that will in turn implement the delivery of coupons and other promotional offers—even applications—to the portable devices, through use of a server system, on behalf of the company.

At specific intervals, time of day, days of the week or any combination thereof, the system of the present invention will send information about the offer/coupons to the mobile devices. The system of the present invention may track the number of offers sent to the mobile device, the number of offers read on the device, and the number of redemptions for each offer. In one embodiment of the present invention, this allows a real-time statistical analysis of each offer so the retailer can fine tune their marketing efforts. U.S. Pat. No. 6,230,143, incorporated herein by reference, discloses a system for analyzing and maintaining coupon redemption data.

The delivery system of the present invention establishes bidirectional communication with the portable device 300, enabling the delivery system to furnish data that allows the business or company issuing the coupons to analyze the effectiveness of the coupon/offers in a nearly real-time manner. For example, the system may allow the business to know how many offers/coupons were sent, viewed, and redeemed by the end-users almost instantly at the expiration of the offer/coupon. This functionality allows the business to instantly access data that will determine the effectiveness of a coupon/offer.

The portable device's communication with the server 901 enables the server to keep track of the number of offers sent to the device and the number of offers read on the device. The application in the portable device may upload to the server information indicating the number of offers read.

In one embodiment, the number of redemptions can be tracked by the server based on information forwarded by the cashier at a redeeming location. When a cashier scans a bar code associated with the coupon, the cashier may obtain the portable device's ID encoded in the bar code. This ID may then be forwarded to the server by the location that honored the coupon together with a reimbursement request. Upon receipt of aggregate redemption information, the server is able to calculate the number of redemptions by a specific user of per offer. Alternatively, the application itself may keep track of redeemed offers and may upload this information directly to the server.

One embodiment of the present invention implements a Points Program. Using the token to identify each device, for example, the system of the present invention keeps track of the number of coupon redemptions per device. Once the client-specified redemption thresholds have been attained (e.g., 20 redeemed coupons for Burger Joint hamburgers), a special offer is sent to the portable device as a reward for achieving the threshold.

The foregoing description of possible implementations consistent with the present invention does not represent a comprehensive list of all such implementations or all variations of the implementations described. The description of only some implementation should not be construed as an intent to exclude other implementations. Artisans will understand how to implement the invention in many other ways, using equivalents and alternatives that do not depart from the scope of the following claims. For example, the present invention may be implemented as a method for delivery to a mobile device of other information having an associated expiration date, such as for example boarding pass information that is pushed onto a user's mobile device a few hours before a flight and which expires shortly after takeoff, for security purposes. In that implementation of the invention to board an airplane the boarding pass code may be displayed by the mobile device together with a picture of the user. Moreover, unless indicated to the contrary in the preceding description, none of the components described in the implementations are essential to the invention.

What is claimed is:

1. A method and system for handling an electronic coupon corresponding to a redeemable coupon or pass with an expiration date comprising:
at a portable multifunction device, receiving a notification from an electronic coupon provider that electronic coupon information is available for displaying;
at the portable multifunction device, opening an application to access said electronic coupon information; and
at the portable multifunction device, displaying an image corresponding to said electronic coupon.

2. The method of claim 1, wherein said image includes an alphanumeric code.

3. The method of claim 1, wherein said image includes a graphical pattern of lines or geometric figures.

4. The method claim 3, wherein said image includes a bar code.

5. The method of claim 1, wherein said electronic coupon information is purged from the portable multifunction device on the expiration date.

6. The method of claim 5, wherein the electronic coupon information is purged upon instruction from the electronic coupon provider.

7. The method of claim 5, wherein the electronic coupon information is purged through a software time bomb mechanism.

8. The method of claim 1, further comprising displaying a map of establishments close to the location of the multifunction device where the electronic coupon may be redeemed.

9. The method of claim 1, wherein said portable device displays an image corresponding to a payment account.

10. The method of claim 1, wherein said portable device displays an image of a user of the portable device.

11. The method of claim 9, wherein said payment account is a credit card account.

12. The method of claim 9, wherein said payment account is a debit card account.

13. The method of claim 9, wherein said image corresponding to a payment account comprises a graphical pattern of lines or geometric figures.
